(19) United States
(12) Patent Application Publication
(10) Pub. No.: US 2013/0189065 A1
(43) Pub. Date: Jul. 25, 2013

(54) Device for the loading/unloading of goods

(71) Applicants: Matteo Zoppi, Genova (IT); Rezia Molfino, Genova (IT)

(72) Inventors: Matteo Zoppi, Genova (IT); Rezia Molfino, Genova (IT)

(21) Appl. No.: 13/748,588

(22) Filed: Jan. 24, 2013

(30) Foreign Application Priority Data
Jan. 24, 2012 (IT) GE2012A000009

(51) Int. Cl. B66F 9/12

(52) U.S. Cl. CPC B66F 9/12
USPC 414/671

(57) ABSTRACT

A device for the loading/unloading of goods includes a storage room, having an aperture located on a plane parallel to the back wall, and a system for the loading/unloading of the goods having a picking fork, which in turn includes a support slider configured to carry two or more fork prongs and to translate along the bottom floor of the storage room from the back wall in the direction of the aperture and vice versa, such that the two or more fork prongs move from a retracted configuration to an extracted configuration. The two fork prongs may be repositioned vertically and be mounted on guides present on the support slider, such that each of the two fork prongs translates independently from the other in a direction parallel to the plane of the bottom floor.

### FIELD OF THE INVENTION

The present invention relates to a device for the loading/unloading of goods that includes a storage room and means for the loading/unloading of the goods.

The storage room comprises an inner space delimited at the bottom by a bottom floor and laterally by lateral walls, one of such lateral walls being the back wall. The storage room further has an aperture opposite to the back wall.

The means for loading/unloading comprise at least one picking fork, that in turn comprises a support slider configured to carry at least two fork prongs, the support slider being configured to translate along the bottom floor from the back wall in the direction of the aperture and vice versa, such that the at least two fork prongs move from a retracted configuration to an extracted configuration. In the retracted configuration, the fork prongs are fully contained in the inner space.

The present invention also provides for the vertical repositioning of the two fork prongs, such that the transition from the extracted condition to the retracted condition of the fork prongs enables the loading/unloading of the goods from within the inner space.

The scope of the invention further includes forklift trucks for the loading/unloading of goods, in particular for the handling of goods loaded in pallets, or in special containers, usually used for delivery and distribution.

### BACKGROUND OF THE INVENTION

A wide variety and different types of forklifts and associated devices are presently available that are suitable for the loading/unloading of goods.

In general, the devices for the loading/unloading known according to the prior art include means for the loading/unloading that consist of a fork supported by a fixed support slider movable along a vertical plane, in order to load and unload packages.

However, the use of forklifts in the prior art is limited primarily to the handling of goods within a restricted environment, for example for the distribution of packages arriving within a warehouse and the positioning of the packages in the areas designated to store them within the warehouse.

A first problem known from the forklifts found in the prior art is inefficiency during transport. The loading/unloading devices found in the prior art allow, in fact, the loading of one package at a time since that package is positioned on the forks during transport.

This configuration requires several trips of the truck for the transport of an elevated number of packages.

At the same time, the particular shape of the forks gives the forklift high overall dimensions, making it difficult to handle the forklift and banning use of the forklifts outside of a protected environment, for example in the streets where common vehicles circulate.

Therefore, there is an unmet need to provide a device for loading/unloading goods that can handle various packages simultaneously and that solves all the typical disadvantages of the forklift and loading/unloading devices in the prior art.

### SUMMARY OF THE INVENTION

The present invention improves the prior art by providing a device for loading/unloading goods as described above, wherein at least two fork prongs are mounted on linear guides provided on the support slider, such that each of the at least two fork prongs moves independently of the other, at least in a direction parallel to the plane of the bottom floor.

The storage room can have any size and must have at least one aperture. It can also be defined only by the bottom floor, so as to allow the support of the individual packages, without the presence of one or more of the lateral walls.

According to an improvement, the support slider is constituted of at least one slender element, the body of the slender member being orthogonal to its direction of translation. The at least two fork prongs have a relative movement between each other, in a direction that can be both parallel and perpendicular to the plane of the bottom floor.

The displacement of the fork prongs along a vertical plane allows the loading of packages, which are carried by the fork prongs and then positioned inside the storage room due to the translation of the support slider that drives the forks back and forth from extracted to retracted position.

The independent displacement of the single fork prongs permits the adaptation of the device for the loading/unloading of goods, subject of the present invention, to any form and dimension of the package to handle.

Taking as reference the plane of the bottom floor as the horizontal plane, the fork prongs can move along this plane both in the direction of the aperture, thanks to the translation of the support slider, and in the direction perpendicular to the bottom floor thanks to the relative movement between the two.

The first displacement is realized simultaneously by both fork prongs given that they are attached together to the support slider, while the second displacement can be realized either simultaneously or independently.

Similarly also the displacement along the vertical plane can be carried out independently by each of the fork prongs, or simultaneously.

The different displacements of the support slider and fork prongs can be actuated through any technology, but it is preferred to use electrical, mechanical or hydraulic actuators capable of regulating the entire operation of the device for the loading/unloading of goods subject of this invention.

The operation of these actuators can be done either manually or automatically through the appropriate control devices connected to the device, subject of this invention.

According to the preferred embodiment, the storage room presents at least one support element mounted inside of the inner space at some distance from the back wall so as to delimit a volume of passage between the back wall and the support element. This volume of passage permits the displacement of at least two fork prongs beneath the support element.

As it will be fully described through the illustration of an example, this configuration presents the advantage to allow the load of more than one package at a time.

In fact the fork prongs load the package inside the storage room adapting themselves to its dimensions thanks to the translation of the support slider.

The package is positioned in the support element that at the same time allows the displacement of the support slider and forks, this, given its elevated position.

Once the package is positioned, the fork prongs can be used again to handle another package, which can be accommodated inside the storage room either at the side of the first package or on top of it.

Following an improvement, each of the fork prongs is designed as a member with an “L” shape, presenting a first portion of the “L” shape parallel to the back wall and a second portion parallel to the bottom floor.

According to such configuration, the means for moving the forks in the vertical direction are foreseen to be preferably mounted on the first portion of the “L” shaped member.

Advantageously, the support element can be designed as a member with an “L” shape as well, having also a first portion parallel to the back wall and a second portion parallel to the bottom floor, connected to the walls of the storage room at two terminal interfaces.

In particular, the support element is connected to the back wall at a terminal interface of the first portion of the “L” shape and to the bottom floor through another terminal interface of the second portion of the “L” shape.

The dimensions of the support element, as well as the way in which it is connected to the walls of the storage room are such as to allow the passage of the fork prongs beneath the support element, so that these elements can translate inside of the inner space giving the capability to load more than one item.

Alternatively the support element is designed as a member with an “L” shape which has a first portion parallel to the back wall and a second portion parallel to the bottom floor, as described previously, but in this case the support element is only connected to the back wall by one terminal interface of the first portion of the “L” shaped element.

The second portion of the element with an “L” shape is not fixed to the bottom floor, creating a cantilever.

Therefore, one of the advantages of this invention is the possibility to handle two or more packages at the same time, independently of their shape.

Hence, given a particular implementation, at least one of the lateral walls, in particular the back wall, is provided with at least one linear guide permitting the translation of the support element, actuated by the fork prongs during their respective translation.

Therefore, the position of the support element can be regulated directly by the fork prongs that reposition it along the linear guide adapting, in this way, the storage room to the shapes of the different items to be handled.

As can be seen in the following images, it is possible to provide at least one support base inside the inner space, made of a slender element, at a distance to the bottom floor, with its longitudinal axis pointing towards the aperture.

The presence of such support base allow an increase in the surface in which to hold the items without taking away the possibility of translating the fork prongs and the support slider along the back wall plane, given that such base is at a distance from the bottom floor.

The invention at hand, relates also to a forklift truck for the loading/unloading of goods, comprising at least one storage area, means to load/unload such goods, actuation devices and their corresponding actuation devices as well as the necessary control means for the loading/unloading elements; where the means for loading/unloading consist of at least one picking fork. The picking fork consists, in turn, of a support slider, able to carry at least two fork prongs. The support slider translates inside the storage area in such a way that the two fork prongs go from a withdrawn position, in which the fork prongs are fully contained in the storage area, to an extracted position.

Furthermore the at least two fork prongs are supported in such a way that each of them translates independently to one another in at least a direction parallel to the horizontal plane of the storage area.

The forklift of this invention, may exhibit one or more of the previously described characteristics for the loading/unloading device.

The forklift of this invention has the necessary characteristics to be applied in the distribution of goods of the so called “last mile,” namely, the distribution of goods occurring from loading goods at a big distribution warehouse to the unloading of the goods to retail shops.

Consequently, the forklift of this invention should be as autonomous as possible; meaning that it should be capable of loading/unloading goods autonomously in predetermined places.

The possibility to contain the forks in the storage area gives the forklift small enough footprint to circulate in areas of the city where normal vehicles circulate.

Preferably, the forklift will present all of the state of the art vehicles characteristics, in particular those relating to eco-sustainability, electric vehicles, etc.

This truck would therefore reduce the use of vans and/or couriers to realize the distribution of the merchandise around the city, contributing substantially to the reduction of traffic and pollution.

The forklift truck can be controlled by an operator positioned inside the truck, within a determined driving area, or remotely outside of the truck.

It is in fact possible to provide, in combination with the forklift, a management system of more trucks. The management system guides each individual forklift truck in order to distribute the loaded merchandise at a preset place.

It is then possible to realize a distribution network created by a train of this forklift trucks, departing from a central warehouse and divided into different areas of the city to distribute the merchandise to the single shops.

The delivery time, the trajectory to follow and the number of packages to deliver can be programmed with efficiency, while the displacement of each truck can be traced and managed remotely.

### BRIEF DESCRIPTION OF THE DRAWINGS

This and other characteristics and advantages of this invention will be clarified by the following description of some embodiments and their respective attached drawings:

FIG. 1a illustrates the loading/unloading device of goods of this invention of one particular embodiment. The two fork prongs are in the retracted position; FIG. 1b shows the loading/unloading device of this invention for the same embodiment, but with the fork prongs in the extracted position.

FIG. 2a shows a view of the means for the loading/unloading of goods of the present invention; FIG. 2b shows a cross section along a longitudinal plane of FIG. 1b. In FIGS. 3a to 3d, the steps of loading/unloading goods realized with the device subject of this invention are shown.

FIG. 4 illustrates a different embodiment of the loading/unloading device of the present invention.

FIGS. 5a to 5d show the loading/unloading steps according to the embodiment shown in FIG. 4.

FIG. 6 shows yet another possible embodiment of the loading/unloading device subject to this invention.

### DETAILED DESCRIPTION OF EMBODIMENTS OF THE INVENTION

The above figures illustrate preferred embodiments of the device for the loading/unloading of goods that is an object of the present invention and are not to be considered limiting to the inventive concept, but rather simply explanatory of the same.

Following such embodiments, the device object of the present invention is provided in combination with locomotion means in order to produce a forklift truck according to the present invention.

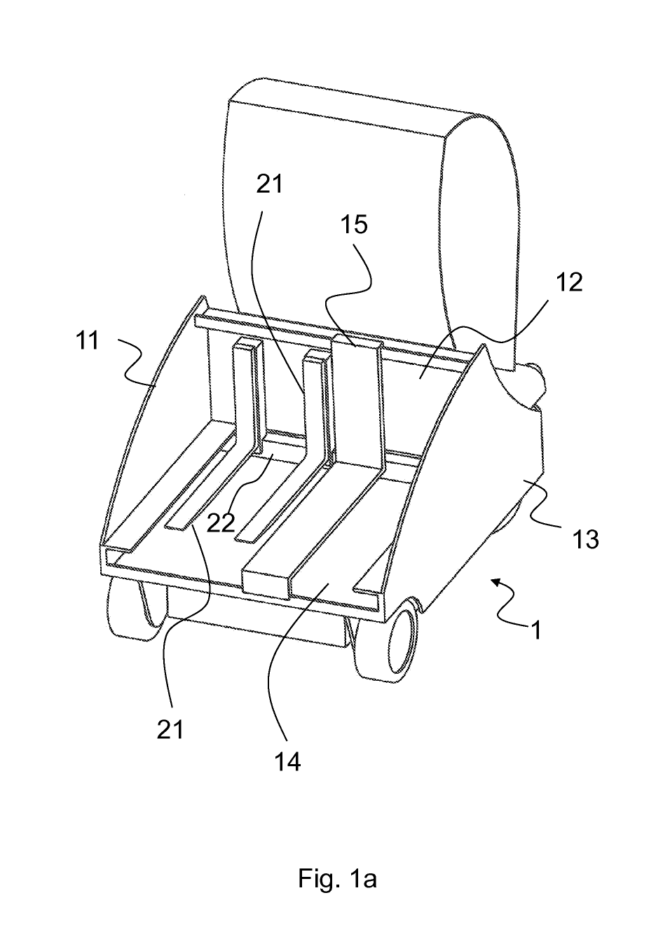

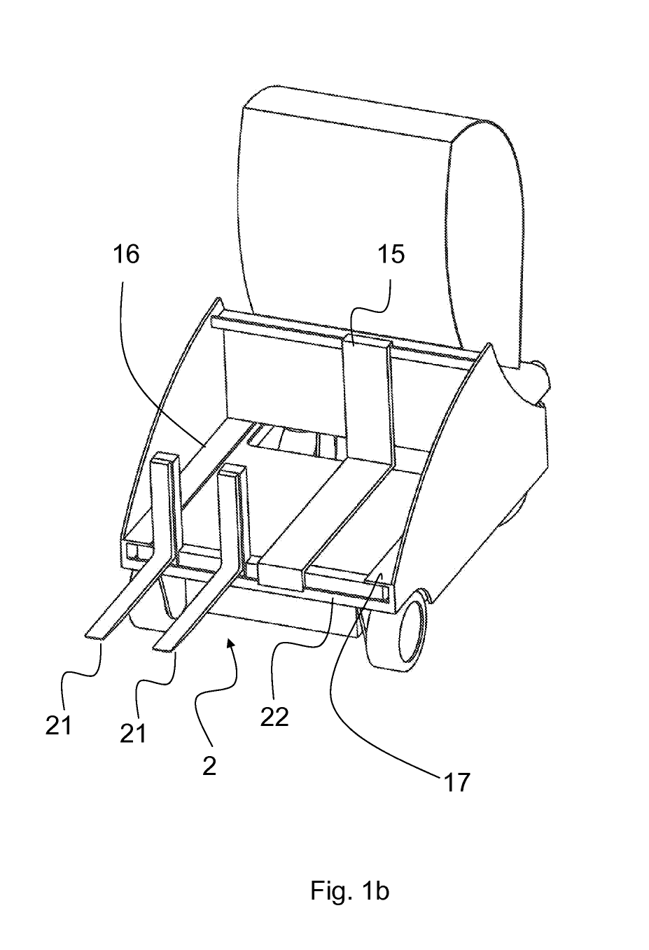

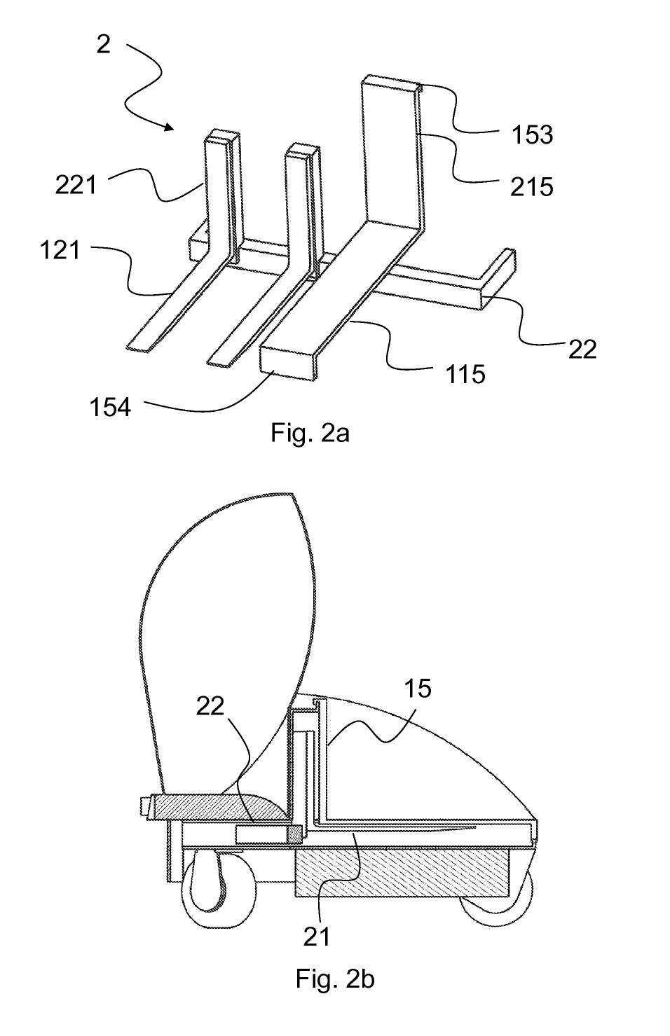

According to FIGS. 1a, 1b, and 2 the loading/unloading device comprises a storage area for goods 1 and the means to load/unload the goods.

The storage area 1 defines an inner space where the means for the loading/unloading 2 of goods are mounted. The inner space is delimited at the bottom by a bottom floor 14 and laterally by three lateral walls 11, 12 and 13, one of such lateral walls being the back wall 12. The storage area 1 further has an aperture through which it will be possible to deliver to the storage room 1 the different packages to load and unload.

The means for the loading/unloading 2 comprise a picking fork, which in turn comprises a support slider 22 designed to carry two fork prongs 21. The support slider 22 translates along the bottom floor 14 from the back wall 12 in the direction of the aperture and vice versa. This means that the support slider 22 is mounted to slide along linear guides located on the bottom floor 14, in a direction going from the back wall 12 to the aperture.

The translation of the support slider 22 is such that the fork prongs 21 can move from a withdrawn position, in which the fork prongs 21 are fully contained in the inner space as shown in FIG. 1a, to an extracted position shown in FIG. 1b, where the fork prongs 21 are entirely outside of the inner space.

Means are also present for a vertical repositioning of the two fork prongs 21, in such a way that the transition from the extracted to the retracted position allows the loading/unloading of goods inside the storage area 1.

As it will be described hereinafter, once the support slider 22 reaches the maximum stroke to achieve the extracted position, the fork prongs 21 can be translated along a vertical axis, perpendicular to the bottom floor 14, to load the packages.

The fork prongs 21 are mounted in such a way that each of the two fork prongs 21 moves independently from the other one in at least one direction parallel to the plane of the bottom floor 14.

Preferably, each fork prong 21 is mounted on a linear guide that enables its translation along part of the length of the support slider 22.

In particular, the support slider 22 is made of a slender element that extends in a direction perpendicular to its own translation; this means, it extends along the direction of the two later walls 11 and 13.

The fork prongs 21 can move independently towards both the longitudinal axis of the support slider 22 and towards a vertical axis, perpendicular to the bottom floor 14.

The different displacements of the fork prongs 21 and the support slider 22 can be controlled through any state of the art technology; however it is preferred to use electric and/or hydraulic actuators.

Referring in particular to FIGS. 1a to 2b, the storage area 1 presents at least one support element 15 mounted within the inner space at a distance to the bottom floor 14, in such a way to delimit a volume of passage between the bottom floor 14, the back wall 12 and support element 15 itself, so that the two fork prongs 21 can translate beneath the support element 15.

In particular, each of the fork prongs 21 is produced as a member with an “L” shape, presenting a first portion 121 parallel to the back wall 12 and a second portion 221 parallel to the bottom floor 14.

The support element 15 is also produced as an element with an “L” shape that presents a first portion 115 parallel to the back wall 12 and a second portion 215 parallel to the bottom floor 14.

The support element 15 is fixed to the walls of the storage room in correspondence with two terminal interfaces 153 and 154. In particular, the support element 15 is fixed to the back wall 12 in correspondence to one terminal interface 153 belonging to the first portion 115, while it is fixed to the bottom floor 14 in correspondence with a terminal interface 154 belonging to the second portion 215.

Preferably, the means for moving the fork prongs 21 in a vertical direction are mounted on the first portion 121 of the fork prongs.

The embodiment shown in the figures includes, inside the storage area, two support bases 16 and 17, which are made of a slender element at a distance to the plane of the bottom floor 14, oriented with the longitudinal axis in the direction of the aperture.

The support bases 16 and 17 allow a better positioning of the packages within the storage area 1, given that they contribute to the support of the weight of each package together with the support element 15.

This feature is particularly advantageous in combination with an implementation variant in which the back wall 12 has a linear guide, where the support element 15 can therefore move inside the storage area 1 in order to approach to one or the other support bases 16 and 17.

The displacement of the support element 15 can be controlled by the fork prongs 21. With particular reference to the FIGS. 2b, it is possible to see that the support slider 22 moves from the back wall 12 until it “levels” the fork prongs 21 with the support base 16. Afterwards, the displacement of the fork prong 21, closest to the support base 16 and in the direction of the lateral wall 13, pushes the support base 16 until it reaches the desired position.

The position of the support base 16 will depend on the packages that have to be loaded or unloaded.

FIGS. 3a to 3d show the loading/unloading phases realized with the loading/unloading device subject of this invention.

In FIG. 3a the fork prongs 21 are found in the extracted position and perform a downwards vertical displacement in order to load a pallet 3.

The pallet 3 is lifted by an opposite displacement to the preceding one of the fork prongs 21 and through a translation of the support slider 22 towards the lateral wall 12. The pallet 3 is then inserted to the storage area 1.

The pallet 3 is placed on the support element 15 and a support base 16, so as to relieve the weight and free the fork prongs 21 and the support slider 22, as shown in FIG. 3b.

The positioning of the support base 16 is such as to adapt itself to the specific dimensions of the pallet 3, but this position can change depending on the dimensions of the packages to be carried as described previously.

Once the pallet 3 is positioned, the fork prongs 21 and the support slider 22 are released and free to move, in particular the fork prongs 21 move towards the lateral wall 13 passing bellow the support element 15 thanks to the volume of passage existing between the support element 15, the bottom floor 14 and the lateral wall 12.

The support slider moves in the direction of the aperture passing also below the support element 15 in order to bring the fork prongs 21 to the extracted position and ready for the loading of a second package 4. as is shown in FIG. 3c.

The package 4 is loaded inside the storage area 1 in the same way the package 3 was, as shown in FIG. 3d.

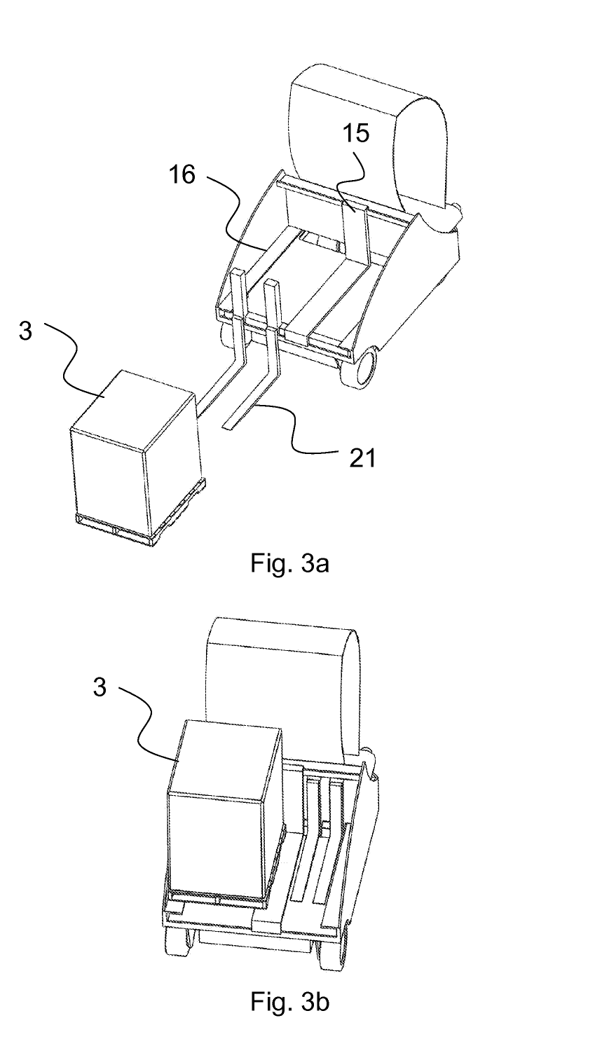

FIG. 4 shows a possible variation in the implementation of a loading/unloading device according to the invention, in which only the support element 15 is used to place the packages, without the usage of the support bases that was described previously.

In particular, in FIG. 4, in order to increase the support vane located at a distance to the bottom floor 14, two support elements 15 are foreseen. However, it is important to specify that the procedure for loading/unloading shown in the following images can be performed with only one support element 15.

This configuration, in particular, enables the loading of packages with such dimensions that could occupy the whole width of the storage area 1 and, at the same time, the loading of packages in a different way with respect with what was shown in previous images 3a to 3d.

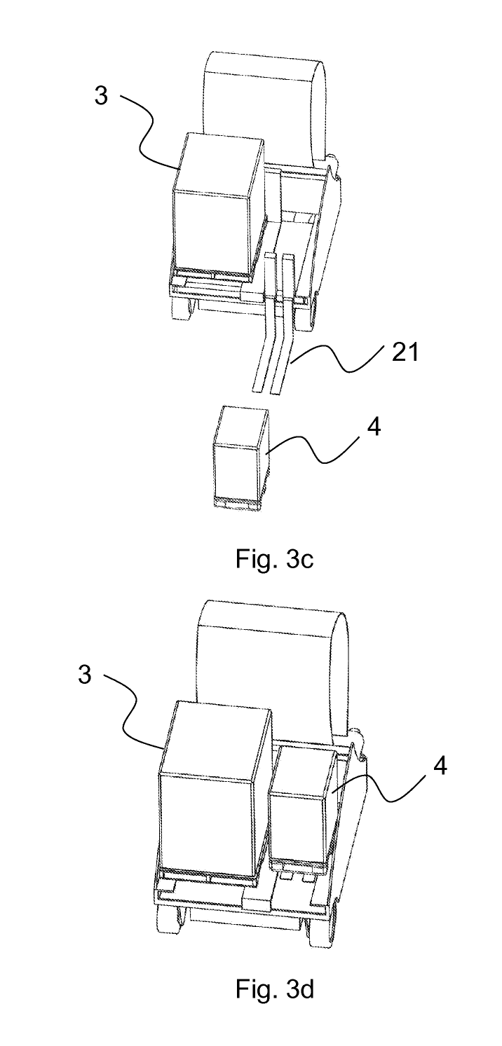

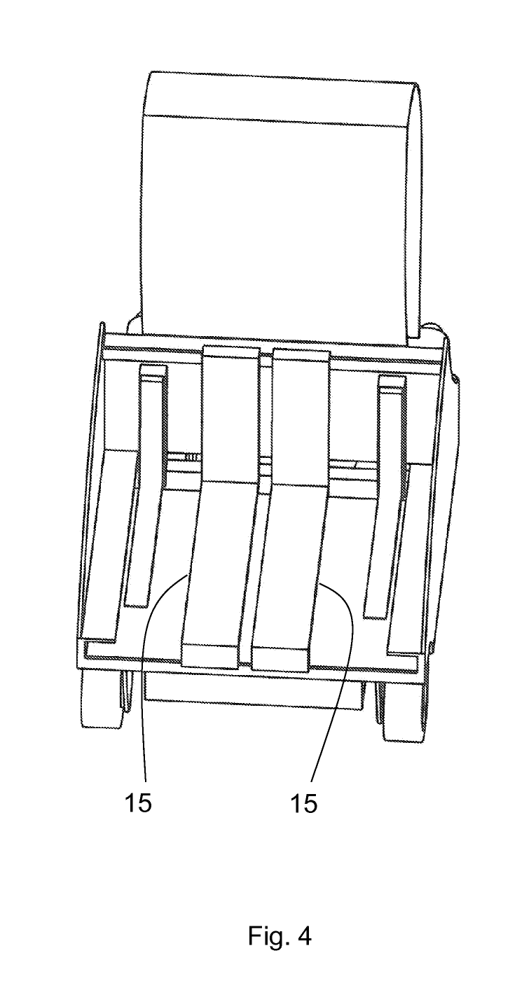

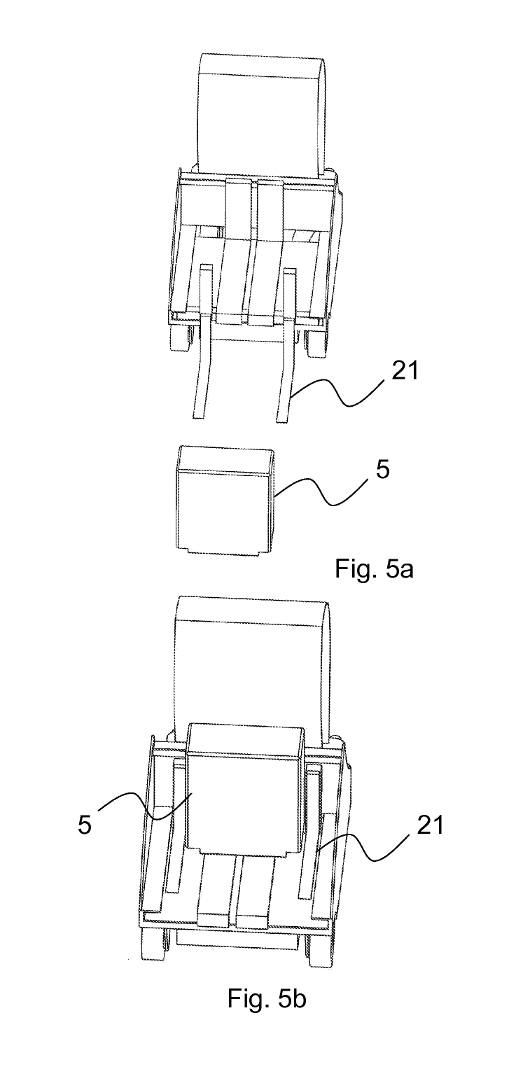

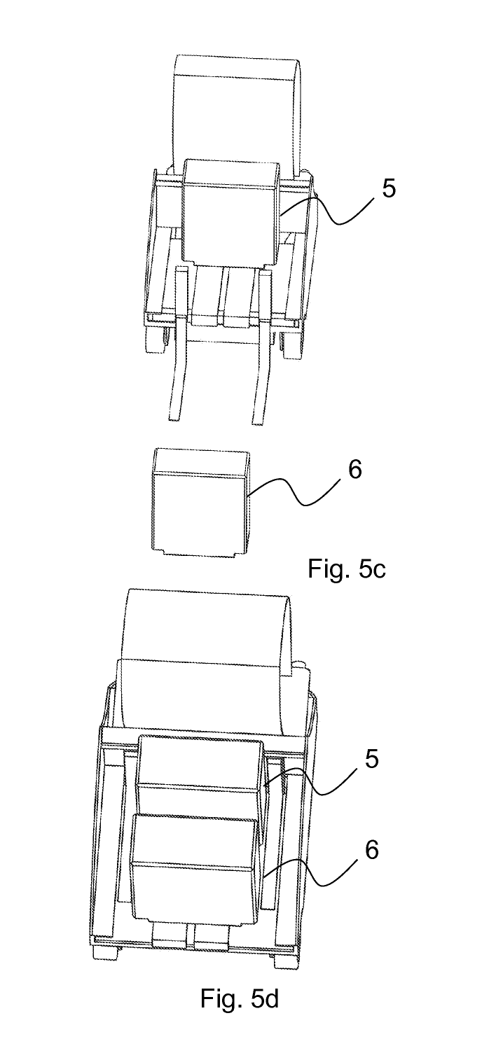

FIGS. 5a to 5d show a possible mode for the loading/unloading of goods using the embodiment variant of the device subject of this invention illustrated in FIG. 4.

As can be seen from the drawings, this embodiment also enables the use of the illustrated mode of FIGS. 3a to 3d.

Referring to FIG. 5a, the fork prongs 21 are in the extracted position and provide a downward vertical displacement in order to load a pallet 5.

The pallet 5 is lifted by the fork prongs 21 with an opposite displacement to the preceding one together with a translation towards the back wall 12 of the support slider 22. This way, the pallet 5 is placed inside the storage area 1.

The pallet 5 is placed then on the support element 15, releasing the fork prongs 21 and the support slider 22 as shown in FIG. 5b.

From this point forward, the fork prongs 21 produce a displacement in opposite directions one with respect to the other, because one of the fork prongs 21 moves towards the lateral wall 11 and the other one towards the lateral wall 13.

The support slider 22 moves towards the aperture and, as soon as it surpasses the bulk of the pallet 5, the fork prongs 21 realize a movement opposite to the preceding step, coming close to each other, such to be able to load another pallet 6 as shown in FIG. 5c.

FIG. 5d shows the loading of the pallet 6 and it can be seen how the disposition of pallets 5 and 6 in the inside of the storage area 1 is made with a different orientation of the pallet with respect to FIGS. 3a and 3d.

From the previous images it can be noted how the device for loading/unloading that is an object of the present invention can be adapted depending on specific needs and dimensions of the packages to handle.

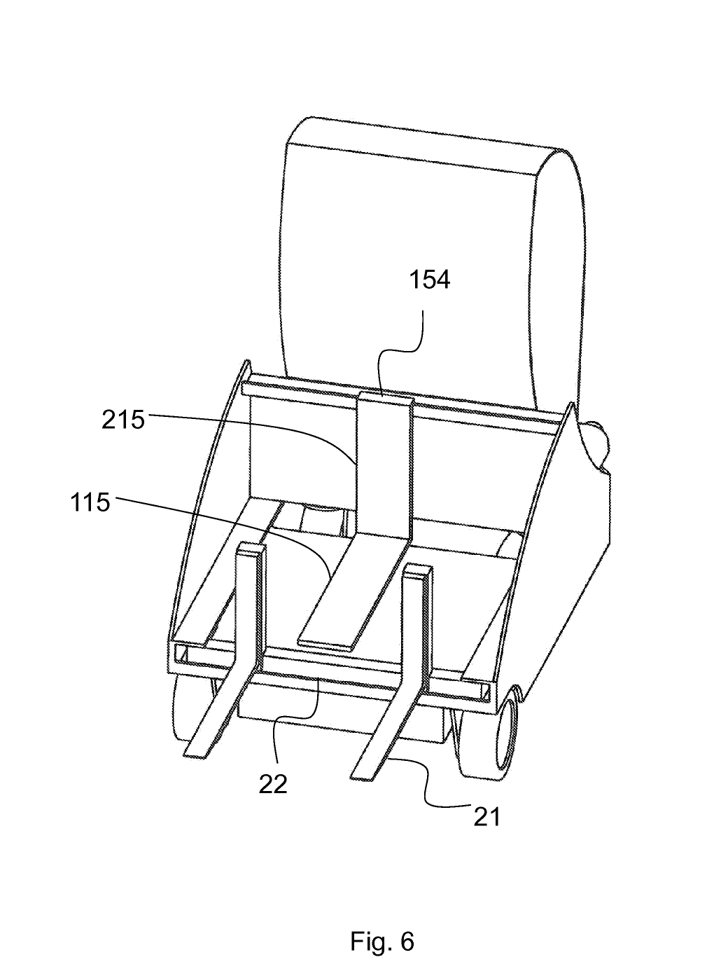

FIG. 6 shows yet another possible embodiment, without altering the concept of the loading/unloading device according to the invention, which includes the usage of an elevated support plane under which the fork prongs 21 can move but it presents a different support element 15.

According to the variant in FIG. 6, the support element 15 is produced as a member with an “L” shape, having a first portion 115 parallel to the back wall 12 and a second portion 215 parallel to the bottom floor 14. The support element 15 is fixed to the back wall 12 through a single terminal interface 153 belonging to the first portion 115.

The support element 15 is mounted hence in “cantilever” position allowing, as shown in FIG. 6, a movement of the support slider 22 along the bottom floor 14, overcoming the entire length of the second portion 215 of the support element 15, in order to realize all the necessary operations for loading/unloading, regardless of the dimensions of the packages to handle.

The invention claimed is:

1. A device for loading/unloading goods comprising:
a storage room (1) for the goods; and
a system for loading/unloading of said goods, said storage room (1) comprising an inner space delimited by a bottom floor (14) and by lateral walls (11, 12, 13), one of said lateral walls being a back wall (12), said storage room (1) having at least one aperture located opposite to said back wall (12),
said system for loading/unloading comprising:
a picking fork comprising a support slider (22) configured to carry at least two fork prongs (21) and to translate along said bottom floor (14) from said back wall (12) towards said aperture and vice versa, such that said at least two fork prongs (21) move from a retracted configuration to an extracted configuration, wherein in said retracted configuration said fork prongs are fully contained in said inner space; and
a system for vertical repositioning of said two fork prongs (21), such that a passage from said retracted configuration to said extracted configuration of said fork prongs (21) enables the loading/unloading of the goods inside said inner space,
wherein the at least two fork prongs (21) are mounted on guides provided on said support slider (22), such that each of said at least two fork prongs (21) translates independently from another one of said at least two fork prong at least in a direction parallel to said bottom floor (14).

2. The device according to claim 1, wherein said support slider (22) comprises at least one slender member having a body in orthogonal position to a direction of translation thereof, said at least two fork prongs (21) being configured to translate along said slender member, one with respect to the other, either along a direction parallel to said bottom floor (14), or along a direction perpendicular to said bottom floor (14).

3. The device according to claim 1, wherein said storage room (1) comprises at least one support member (15) mounted inside said inner space at a distance from said bottom floor (14), such to delimit a volume of passage between said bottom floor (14) and said support member (15), said at least two fork prongs being enabled to translate beneath said support member (15) in said volume of passage.

4. The device according to claim 3, wherein each of said at least two fork prongs (21) is configured as a member with an “L” shape, said member with an “L” shape comprising a first portion (121) parallel to said back wall (12) and a second portion (221) parallel to said bottom floor (14), the system for vertical repositioning of the at least two fork prongs (21) being positioned on said first portion (211).

5. The device according to claim 3,
wherein said support member (15) is configured as a member with an “L” shape, said member with an “L” shape comprising a first portion (115) parallel to said back wall (12) and a second portion (215) parallel to said bottom floor (14), said support member (15) being connected to the walls of said storage room (1) at terminal interfaces, and
wherein said support member (15) is connected to said back wall (12) at a terminal interface (153) of said first portion (115) and to said back wall (14) at a terminal interface (154) of said second portion (215).

6. The device according to claim 3,
wherein said support member (15) is configured as a member with an “L” shape, said member with an “L” shape comprising a first portion (115) parallel to said back wall (12) and a second portion (215) parallel to said bottom floor (14), and
wherein said support member (15) is connected to said back wall (12) of said storage room (1) at a terminal interface (153) of said first portion (115).

7. The device according to claim 3, wherein said back wall (12) has a rail providing for sliding of said support member (15), said support member (15) being repositioned by said at least two fork prongs (21) when said at least two fork prongs (21) translate.

8. The device according to claim 1, further comprising a support base (16, 17) inside said inner space, said support base (16, 17) comprising a slender member positioned at a distance from said bottom floor (14), a body of said slender member being oriented toward said aperture.

9. A fork lift for loading/unloading goods, comprising:
a storage room (1) for goods;
a system for loading/unloading said goods; and
a locomotion system and corresponding command organs and control elements controlling said system for loading/unloading,
wherein said system for loading/unloading comprises at least one picking fork, said at least one picking fork comprising a support slider (22) configured to carry at least two fork prongs (21) and to translate inside said storage room (1), such that said at least two fork prongs (21) move from a retracted configuration to an extracted configuration, said at least two fork prongs being fully contained in said storage room (1) when in said retracted configuration, and
wherein said at least two fork prongs (21) are supported such that each of said at least two fork prongs (21) translates independently from another one of said at least two fork prong at least along a direction parallel to a horizontal plane of said storage room (1).

10. The fork lift according to claim 9, wherein said system for loading/unloading is configured as in claim 1.
